(19) United States
(12) Patent Application Publication
(10) Pub. No.: US 2017/0152930 A1
(43) Pub. Date: Jun. 1, 2017

(54) PRECISELY ALIGNED, FRICTION WELDED SPIRAL BEVEL OR HYPOID RING GEAR AND DIFFERENTIAL CASE ASSEMBLY

(71) Applicant: FORD GLOBAL TECHNOLOGIES, LLC, Dearborn, MI (US)

(72) Inventors: Paul John Bojanowski, Macomb Township, MI (US); Andreas Evangelos Perakes, Canton, MI (US); Thomas Gerard Neumann, Sterling Heights, MI (US); Mark E. Briscoe, Milford, MI (US)

(21) Appl. No.: 14/953,760

(22) Filed: Nov. 30, 2015

(51) Int. Cl. F16H 48/08; B23K 20/12; B23K 20/227; F16H 48/40

(52) U.S. Cl. CPC F16H 48/08; F16H 48/40; B23K 20/129; B23K 20/227; F16H 2048/382

(57) ABSTRACT

A method for manufacturing a ring gear/differential case assembly includes attaching a ring gear to a differential case. The ring gear and the differential case are fabricated of materials having differing properties. The attaching includes placing a first portion of the ring gear in intimate contact with a first portion of the differential case whereby a predetermined gap is defined between another portion of the ring gear and another portion of the differential case. The ring gear first portion is attached to the differential case first portion by a friction welding process. The predetermined gap defines an outflow channel for receiving an overflow material created by an upset forging step of the friction welding process. Differential assemblies and vehicles including such are described.

### TECHNICAL FIELD

This disclosure relates generally to vehicle drive train assemblies. In particular, the disclosure relates to methods for attaching a spiral or hypoid bevel ring gear to a differential case, and to ring gear/differential case assemblies provided according to the method.

### BACKGROUND

As background and with reference to FIGS. 1A and 1B, a representative differential carrier 100 is shown, being the part of a vehicle powertrain responsible for transmitting drive power from the vehicle engine to the vehicle drive wheels. The depicted embodiment of a differential carrier 100 is for a rear axle differential. However, this should not be taken as limiting, as the skilled artisan is well aware of variations in differential type and design.

The differential carrier 100 includes a gear assembly (indicated generically by reference numeral 102) driven by an input drive shaft 104. Gear assembly 102 is operatively connected to a pair of output drive shafts 106, 106′, whereby torque and rotation are transmitted from a vehicle engine 108 to the vehicle wheels 112 (see FIG. 1B). Of course, additional elements are typically included for transmitting drive power (FIG. 1B, see arrows) from the engine 108 to the wheels 112, such as a torque converter 114, a transmission 116, etc.

Returning to FIG. 1A, a hypoid ring gear and differential assembly 118 is operatively connected to the input drive shaft 104. The hypoid ring gear and differential assembly 118 includes a hypoid ring gear 122 which meshes with a hypoid pinion gear 119 of the differential assembly. As is known, a spiral or hypoid gear is so named for its helically-shaped spiral bevel gear teeth, which produce less vibration and noise than conventional straight-cut or spur-cut gears with straight teeth. As shown, an axis of the hypoid ring gear and differential assembly 118/input drive shaft 104 is substantially perpendicular to an axis of the differential carrier 100/output drive shafts 106, 106′. The ring gear 122 is attached to a portion of a differential case 120, which as is known is a housing for the differential carrier 100, in a configuration providing a required meshing between the ring gear 122 and the hypoid pinion gear 119. Gear assembly 102 may also include a side gear 126. As the input drive shaft 104 rotates, so does the hypoid pinion gear 119, driving rotation of the ring gear 122. By this rotation, torque and rotation are transmitted via output drive shafts 106, 106′ to wheels 112.

Alignment of these components during assembly of an axle or rear drive module is important, since as explained the ring gear 122 must mesh with the hypoid pinion gear 119 in a completed axle or rear drive module assembly to transmit the needed torque/rotation to the vehicle wheels 112. Typically these elements are fabricated of different and potentially weld-incompatible materials. For example, a ring gear 122 is often fabricated of steel or an alloy which may or may not be carburized, and a differential case 120 is often fabricated of nodular ductile iron. Welding such dissimilar materials is challenging at least due to the different material melting temperatures. For this reason, the most common method for attaching the two is to provide a bolt-on connection using conventional fasteners. While effective, such conventional attachment means increase the required labor and attendant cost, and also contribute to undesirable increases in weight and packaging size.

For this reason, welding has been considered as an alternative to conventional fasteners to attach the ring gear to the differential case. Laser welding has been attempted to provide a strong attachment despite the incompatibility of the materials of which the hypoid ring gear and differential case are fabricated. In laser welding, typically a nickel feed wire is used to provide a strong and consistent weld in spite of the above-mentioned incompatibility in materials. Disadvantageously, the high weld temperatures and rapid cooling rates associated with laser welding can cause a drive ring gear to become distorted or warped, preventing the required precise alignment between the ring gear and the mating pinion gear. Moreover, conventional laser welding techniques produce weld spatter that may bond onto the teeth of the ring gear and other components of the vehicle differential assembly, potentially resulting in wear and reduced lifespan and/or failure of the componentry. Likewise this condition may manifest itself as an undesirable Noise/Vibration/Harshness result in the final axle/vehicle assembly. To avoid such weld spatter, it is necessary to provide shielding and to implement post-welding maintenance and cleaning protocols. Moreover, laser welding is highly energy-inefficient compared to other welding techniques and requires specialized safety and maintenance protocols due to the use of laser technology. Still more, components to be laser welded must be extremely clean, most commonly laser-cleaned. Each of these factors undesirably adds to labor requirements and attendant costs of manufacturing/assembling a hypoid ring gear/differential case assembly.

Thus, a need is identified in the art for improvements to processes for joining ring gears to differential cases during vehicle drivetrain/powertrain manufacture and assembly.

### SUMMARY

In accordance with the purposes and benefits described herein and to solve the above-summarized and other problems, in one aspect a method of making a ring gear/differential case assembly is described, comprising providing and aligning a differential case having a differential case flange and a ring gear having a ring gear flange. The ring gear flange and differential case flange are dimensioned and held adjacent to one another to, when attached, provide a required alignment and meshing of the ring gear with a cooperating hypoid pinion gear. A predetermined tolerance or fit is provided between an outer diameter of the ring gear and an inner diameter of the differential case flange, such as by configuring the machinery used to hold the two components adjacent one to the other for attaching, whereby a gap of predetermined dimensions is provided between at least a portion of the two. In embodiments, this is accomplished by holding the differential case coaxially at each hub thereof. In turn, the ring gear is held by a suitable holder, for achieving the proper alignment and predetermined tolerance.

Next, a friction welding process is used to attach the ring gear flange to the differential case flange, whereby the predetermined gap provides an overflow channel between the ring gear and the differential case for receiving overflow material or flash created during a friction welding upset forging step. In this manner, contamination of differential components by such overflow material is avoided. Further, any need for post-welding cleanup is substantially avoided, without impact on component form, fit, or function. In embodiments, a predetermined gap of from 0.01 to 0.1 inches is provided.

In other aspects of the disclosure, ring gear/differential case assemblies are provided, made according to the disclosed methods.

In the following description, there are shown and described embodiments of the disclosed ring gear/differential case assembly and method of making. As it should be realized, the described assembly and method are capable of other, different embodiments and their several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed ring gear/differential case assembly and method of making, and together with the description serve to explain certain principles thereof. In the drawings:

FIG. 1A depicts an isolated view of a prior art axle carrier assembly;

FIG. 1B depicts a prior art vehicle and vehicle drivetrain;

FIG. 2 shows a cross-sectional side view of a ring gear/differential case assembly according to the present disclosure, illustrating a back-face weld;

FIG. 3 shows a cross-sectional side view of the ring gear/differential case assembly of FIG. 2, illustrating an inside weld; and

FIG. 4 depicts a representative friction welding device for making the ring/gear differential case assembly of FIG. 2.

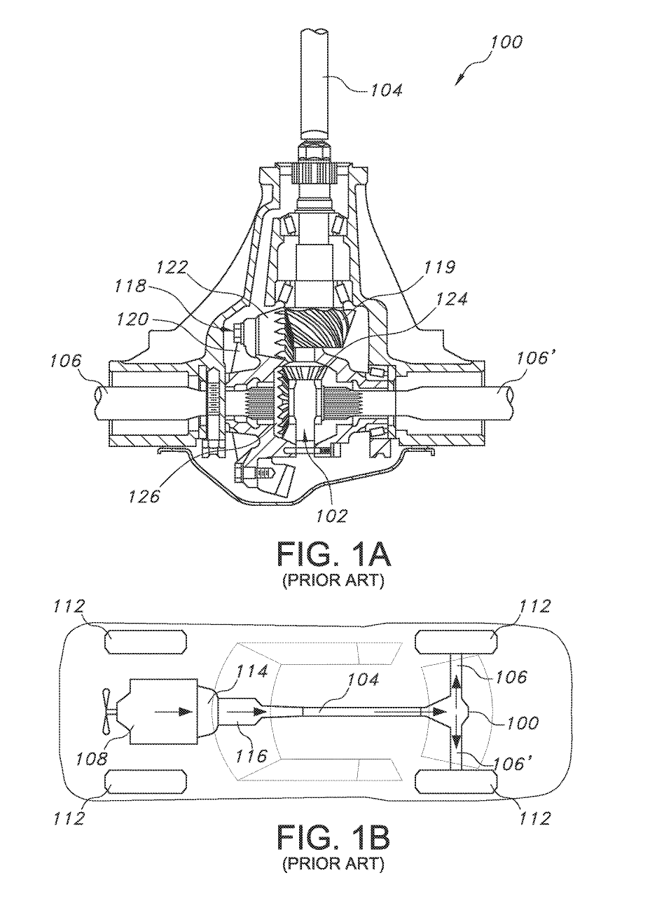

Reference will now be made in detail to embodiments of the disclosed ring gear/differential case assembly and method of making, examples of which are illustrated in the accompanying drawing figures wherein like reference numerals indicate like features.

### DETAILED DESCRIPTION

As summarized above, the dissimilar materials of which the two components are fabricated (for example, steel or an alloy for the ring gear 122 and nodular ductile iron for the differential case 120) present engineering challenges in connecting/joining the two. In turn, the problem of precise alignment of components to provide a suitable meshing of the ring gear 122 and the hypoid pinion gear 119 must be addressed.

Friction welding is a solid-state welding process whereby heat is generated through a mechanical friction imposed upon workpieces placed in contact with one another. During the process, additional lateral forces (“upset” forces) are imposed to plastically displace and fuse the materials of the workpieces. At a high level, the molecules of the dissimilar materials are placed under sufficient frictional heat and pressure to form bonds. Because no material melt occurs, friction welding is not a welding process in the traditional sense but is actually a forging technique. The fast joining times and direct heat input at the weld interface provided by friction welding result in relatively small heat-affected zones. Moreover, friction welding techniques are substantially melt-free, avoiding grain growth in engineered materials. Still more, the relative motion generated between surfaces during friction welding provides a cleaning effect on the surfaces of the materials being joined. Thus, less preparation of workpiece surfaces is required before and less cleaning of workpiece surfaces is required after the friction welding process.

Friction welding is advantageous also in that strong bonds between very dissimilar materials can be achieved without need of additional fasteners. The difference in melting temperatures of dissimilar materials such as steel/alloys and nodular ductile iron precludes the use of conventional welding techniques. However, as explained above friction welding does not require material melt, but instead provides frictionally-induced plastic displacement and fusion of the molecules of dissimilar materials. This provides a full strength bond between dissimilar materials with no additional weight and, as noted above, requires no post-welding cleanup. A number of variants of friction welding are known in the art, including spin welding, linear friction welding, friction surfacing, linear vibration welding, angular friction welding, and orbital friction welding. Each method shares the same advantage, i.e. not requiring melting of either material, but instead employing frictional heat to create a plastic zone between two dissimilar materials whereby exertion of an external force (upset) forges the materials into a single, homogenous material interface.

Yet another advantage of friction welding is that dissimilar materials can be precisely aligned for joining, since by controlling the amount of material upset it is possible to provide very narrow tolerances in automated processes. In turn, because friction welding processes require lower temperatures than conventional welding techniques, components may be joined during later stages of a fabrication or machining process, for example at final assembly, without need of post-welding clean-up or other processes. Even more, the risk of component warping/distortion is reduced, also due to the lower temperatures associated with friction welding.

An engineering challenge to be overcome in implementing friction welding to join a ring gear 122 to a differential case 120 was the creation of overflow material or “flash,” i.e. small particles of workpiece material that are forced out of the working mass during the friction welding/upset process. These small particles could potentially deposit within other elements of the differential carrier 100, causing damage to the gear assembly 102 and other components therein and reducing component useful lifespan. While this could be addressed by a post-friction welding cleaning step, it was desired to avoid the additional labor and attendant costs.

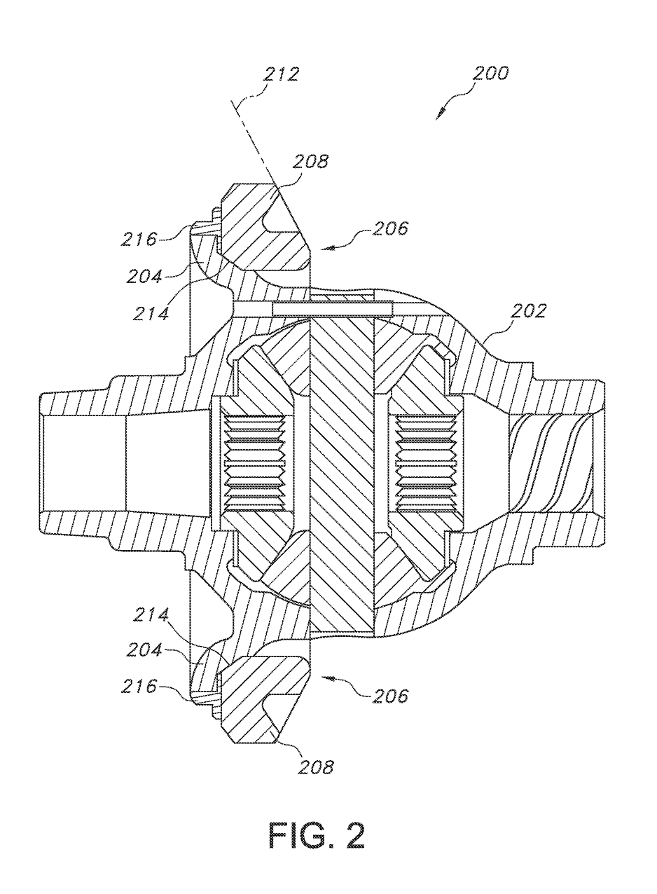

To solve this and other problems, with reference to FIG. 2 there is shown in isolation a ring gear/differential case assembly 200 according to the present disclosure. As shown, the assembly 200 includes a differential case 202 which as described above is often fabricated of a first material such as nodular ductile iron. The differential case 202 includes or defines a flange 204 having an inner diameter.

FIG. 2 also shows a ring gear 206 having a ring gear flange 208 defining an outer diameter. Ring gears 206 are typically fabricated of a second material such as steel or an alloy having different physical properties than the first material, such as hardness, melting temperature, etc. As shown in the drawing figures, the ring gear flange 208 must be connected to a differential case flange 204, whereby after assembly the needed alignment and meshing of the ring gear 206 with a cooperating hypoid pinion gear (not visible in this view) is provided.

To accomplish this, the ring gear flange 208 and differential case flange 204 are held for the friction welding process whereby intimate contact is provided along a portion of the ring gear flange 208 and the differential case flange 204, but also whereby a predetermined gap 214 is defined between a portion of the outer diameter of the ring gear flange 208 and an inner diameter of the differential case flange 204. This is accomplished in an embodiment by configuring the automated machinery used to hold the two components adjacent one to the other for the attaching to provide the desired gear meshing/alignment, the intimate contact between a portion of the ring gear flange 208 and differential case flange 204, and the predetermined gap 214.

In embodiments, this is accomplished by holding the differential case 202 coaxially at each hub thereof. In turn, a holder is provided to which the ring gear 206 is secured, for achieving the proper alignment and predetermined gap 214. In an embodiment, the predetermined gap 214 is at least 0.01 inches, although it will be appreciated that alternative gaps/tolerances may be required in accordance with differing differential assembly configurations and/or dimensions.

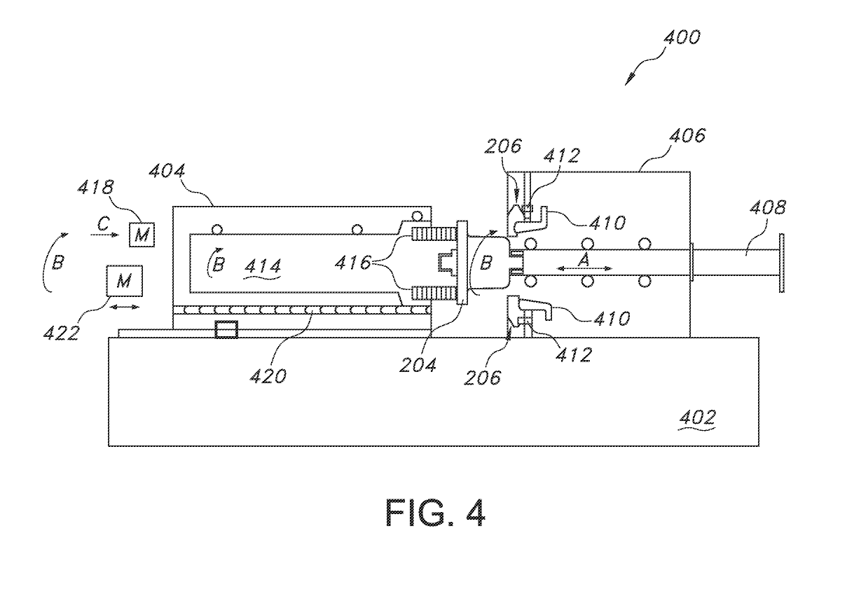

Next, a friction welding process is used to attach the ring gear shoulder 208 to the differential case pilot 204. As summarized above and as is known to the skilled artisan, friction welding results from heat generated through mechanical friction imposed by a friction welder (see FIG. 4) on the contacting surfaces of the ring gear flange 208 and the differential case flange 204. During the process, additional lateral forces (often referred to as an upset forging step) are imposed by the friction welder to plastically displace and fuse the different materials of the ring gear flange 208 and the differential case flange 204, thus forming a weld or fusion 216 between the two. A friction welding tool controller configured to set a pitch line 212 of the ring gear 206 to a desired angle relative to the orientation of the differential case 202.

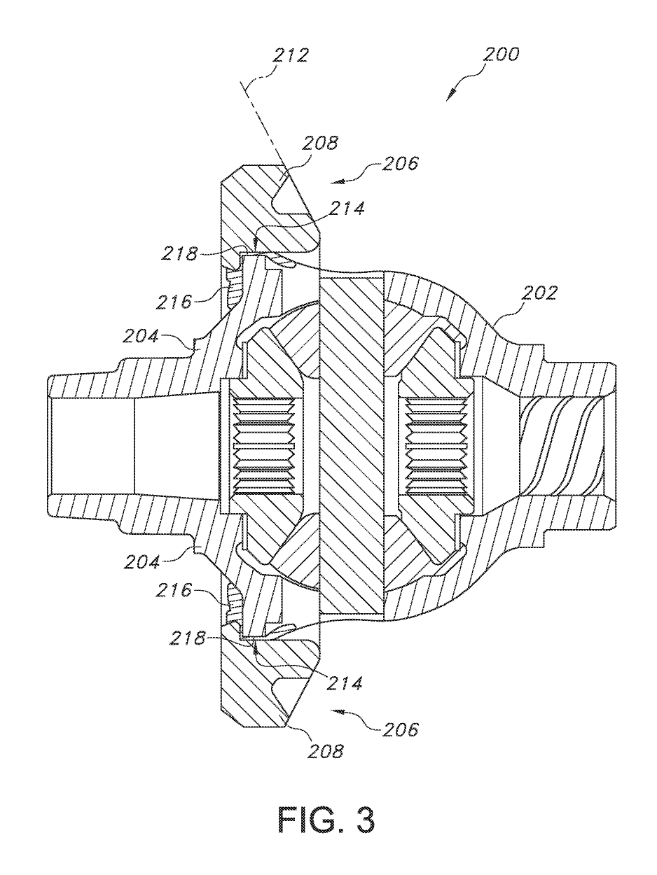

With reference to FIG. 3, as shown therein the providing of a predetermined gap 214 also creates an overflow channel between the ring gear flange 208 and the differential case flange 204 for receiving overflow material 218 or flash created during a friction welding upset process. As shown therein, the overflow material 218 disperses into the gap 214, without contacting any of the various described elements of the differential assembly. In this manner, contamination of any differential components by overflow material, post-welding cleanup, etc. are substantially avoided, without impact on component form, fit, or function.

The basic elements of a friction welding machine are known in the art, and do not require extensive discussion herein. However, FIG. 4 illustrates a representative friction welding machine 400 applicable to fabricate a ring gear 206/differential case 204 assembly as described above. A base 402 supports the machine 400. The machine includes a rotating portion 404 and a fixed portion 406. The fixed portion 406 includes a biasing element 408 such as a pneumatic or hydraulic cylinder which urges (see arrow A) ring gears 206 held by suitable holders 410 towards a differential case 204 held by the rotating portion 404. Any suitable holder 410 is contemplated, including without intending any limitation clamping jaws having anti-rotate pins 412 as depicted in the drawing figure, a tooth nest plate, and others.

The rotating portion 404 as depicted includes a computer numerical control (CNC)-actuated main spindle 414 under the control of a servo motor. The main spindle 414 is configured to rotate the differential case 204 held by a clamp 416 (see arrows B) by the action of a servo motor 418. A ball screw 420 actuated by a CNC-controlled servo motor 422 urges the clamped differential case 204 (see arrow C) against the ring gears 206 held by the fixed portion 406 as described above. By the combined rotation of the differential case 204 and the upset forging forces imposed by ball screw 420/biasing element 408, the ring gear 206 and differential case 204 are friction welded as described above.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A method for manufacturing a ring gear/differential case assembly, comprising:
attaching a ring gear to a differential case whereby the ring gear aligns and operatively interfaces with a hypoid pinion gear of the differential assembly, the attaching including placing a first portion of the ring gear in intimate contact with a first portion of the differential case whereby a predetermined gap is defined between another portion of the ring gear and another portion of the differential case; and
attaching the ring gear first portion to the differential case first portion by a friction welding process.

2. The method of claim 1, wherein the predetermined gap defines an outflow channel for receiving an overflow material created by an upset forging step of the friction welding process.

3. The method of claim 2, wherein the predetermined gap is at least 0.01 inches.

4. The method of claim 1, wherein the aligning comprises orienting a center line axis of the ring gear in a substantially perpendicular relationship to a center line axis of the hypoid pinion gear.

5. The method of claim 1, wherein the ring gear is fabricated of a first material and the differential case is fabricated of a second material that is different from the first material.

6. The method of claim 5, wherein the first material and the second material differ at least in a melting temperature property.

7. The method of claim 5, wherein the first material is steel or a steel alloy and the second material is nodular ductile iron.

8. A ring gear/differential case assembly manufactured by the method of claim 1.

9. A vehicle including a ring gear/differential case assembly manufactured by the method of claim 1.

10. A vehicle ring gear/differential case assembly, comprising:
a differential case; and
a ring gear attached to the differential case whereby the ring gear will align and operatively interface with a hypoid pinion gear of the differential assembly;
a first portion of the ring gear being friction welded to a first portion of the differential case whereby a predetermined gap is defined between another portion of the ring gear and another portion of the differential case.

11. The assembly of claim 10, wherein the predetermined gap defines an outflow channel for receiving an overflow material created by an upset forging step of the friction welding.

12. The assembly of claim 11, wherein the predetermined gap is at least 0.01 inches.

13. The assembly of claim 10, wherein a center line axis of the ring gear is oriented in a substantially perpendicular relationship to a center line axis of the hypoid pinion gear.

14. The assembly of claim 10, wherein the ring gear is fabricated of a first material and the differential case is fabricated of a second material that is different from the first material.

15. The assembly of claim 14, wherein the first material and the second material differ at least in a melting temperature property.

16. The assembly of claim 14, wherein the first material is steel or a steel alloy and the second material is a nodular ductile iron.

17. A vehicle including an assembly according to claim 10.
